(19) United States
(12) Patent Application Publication
(10) Pub. No.: US 2025/0376585 A1
(43) Pub. Date: Dec. 11, 2025

(54) ASPHALT ADDITIVE

(71) Applicant: HONEYWELL INTERNATIONAL INC., Charlotte, NC (US)

(72) Inventors: Swapnil Kanaujia, Haryana (IN); Anand Shankar S. Mahadware, Gurgaon (IN); Yonghong Ruan, Wayne, NJ (US); Scott Hacker, River Edge, NJ (US)

(73) Assignee: HONEYWELL INTERNATIONAL INC., Charlotte, NC (US)

(21) Appl. No.: 19/083,769

(22) Filed: Mar. 19, 2025

Related U.S. Application Data
(60) Provisional application No. 63/656,391, filed on Jun. 5, 2024.

(51) Int. Cl. C08L 53/02; C08J 3/12; C08L 95/00

(52) U.S. Cl. CPC C08L 53/02; C08J 3/126; C08L 95/00; C08J 2353/02; C08J 2423/06; C08L 2207/062; C08L 2207/53; C08L 2312/00; C08L 2555/84; C08L 2555/86

(57) ABSTRACT

Asphalt additives and methods of producing the same are provided. In an exemplary embodiment, an asphalt additive includes a granule. The granule includes a core, and the granule also includes a coating affixed to an outer surface of the core. The core includes an elastomer, and the coating includes a polyolefin.

### CROSS-REFERENCE TO RELATED APPLICATION

This application claims the benefit of U.S. Provisional application No. 63/656,391, filed Jun. 5, 2024, the entire contents of which are hereby incorporated by reference.

### TECHNICAL FIELD

The present disclosure generally relates to asphalt additives. More particularly, the asphalt additive provides a combination of components that improve asphalt performance.

### BACKGROUND

Certain polymers can be incorporated into bitumen to improve the performance of that bitumen. For example, certain low molecular weight polyolefins or elastomers and/or sulfur can reduce rutting, thus providing superior performance for bitumen roads. However, the individual handling of the additives can be difficult. For example, errors in the weights and/or ratios of the additives can be introduced, and handling of sulfur can be hazardous, especially if combined with certain polymers. Some asphalt producers do not have separate hoppers for multiple additives, so the addition of several additives requires re-using the same hopper for different materials. This increases the time for preparation of the asphalt composition, which increases costs, and also introduces potential issues with cross-contamination when re-using a hopper for different materials.

The process of producing a single product with more than one asphalt additive component can be complicated. There are potential degradation issues, as well as uneven mixing. For example, melting of some components may produce a more consistent, even product, but melting can initiate degradation and begin undesired reactions prior to addition to an asphalt product.

Accordingly, it is desirable to produce asphalt additives that provide an even distribution of components with little to no degradation of the components. Furthermore, the asphalt additive should include desired components in a ratio that can be used to produce a desired asphalt composition without having to incorporate multiple addition steps. Furthermore, other desirable features and characteristics of the present embodiment will become apparent from the subsequent detailed description and the appended claims, taken in conjunction with this background.

### BRIEF SUMMARY

Asphalt additives and methods of producing the same are provided. In an exemplary embodiment, an asphalt additive includes a granule. The granule includes a core and a coating disposed on an outer surface of the core. The core includes an elastomer, and the coating includes a polyolefin.

A method of preparing an asphalt additive is provided in another embodiment. The method includes combining an elastomer and a polyolefin to produce a premix. The temperature of the premix is brought to a mixing temperature that is sufficient to form a coating of the polyolefin over the elastomer, and the premix is mixed at the mixing temperature to form the asphalt additive as a granule. The mixing produces a coating overlying a core, where the core includes the elastomer in an amount of from about 50 to 100 weight percent, and the coating includes the polyolefin in an amount of from about 70 to 100 weight percent, based on a total weight of the asphalt additive.

### BRIEF DESCRIPTION OF THE DRAWINGS

The present embodiments will hereinafter be described in conjunction with the following drawing figures, and wherein:

FIG. 1 is a cross sectional view of one embodiment of a granule of the asphalt additive;

FIG. 2 is a schematic diagram representing an embodiment of a method of producing the asphalt additive; and

FIG. 3 is a schematic diagram representing an embodiment of a method where the asphalt additive has been produced.

### DETAILED DESCRIPTION

The following detailed description is merely exemplary in nature and is not intended to limit the various embodiments or the application and uses of the embodiments described herein. Furthermore, there is no intention to be bound by any expressed or implied theory presented in the preceding technical field, background, brief summary, or the following detailed description.

A composite asphalt additive includes a core comprising an elastomer and a coating overlying an outer surface of the core, where the coating includes a polyolefin. The coating and the core form a granule. A crosslinking agent may optionally be incorporated into the coating. The asphalt additive is formed by mixing the ingredients thereof at a mixing temperature sufficient to form a coating of the polyolefin on the elastomer. There are at least five different embodiments for how to form the asphalt additive, and each embodiment has a different mixing temperature. In all embodiments, the mixing temperature is less than an elastomer peak melting point, such that the elastomer remains in a somewhat solid state to facilitate forming the core. In embodiments with sulfur present as a crosslinking agent, the mixing temperature is less than a sulfur flash point for safety reasons, where the sulfur flash point is about 160 to 210 degrees Celsius (° C.). The lower end of the mixing temperature varies for the different embodiments, and the different embodiments may have different rates for forming the granule, and different degrees of degradation of the asphalt additive. Furthermore, the different embodiments may produce granules having a different degree of coverage for the coating over the core. In all embodiments, the mixing temperature is low enough that degradation is limited.

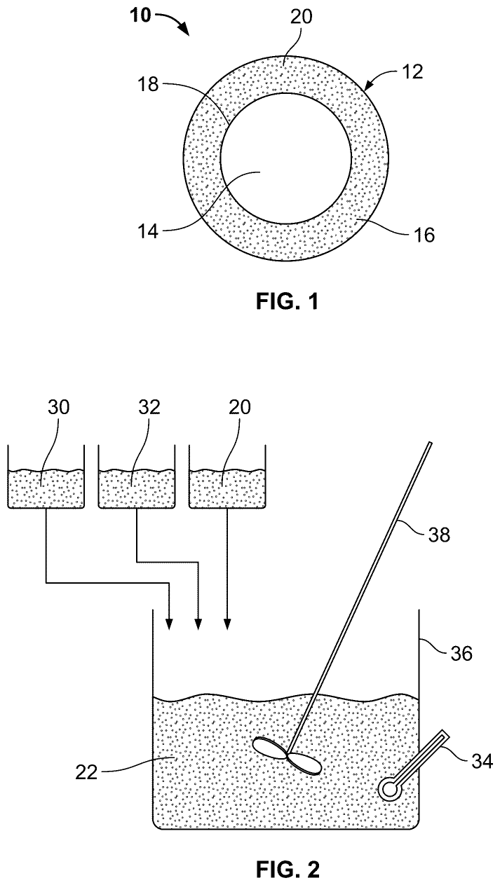

The final asphalt additive product is essentially similar (i.e., an elastomer core covered by a polyolefin coating) in all embodiments, so the description of the asphalt additive applies to all embodiments. Referring to FIG. 1, the asphalt additive 10 includes a granule 12, where the granule include a core 14 and a coating 16 overlying an outer surface 18 of the core 14. The coating 16 may overlay some, most, or all of the core 14 in various embodiments. The granule 12 may be a plurality of granules in some embodiments. The granules 12 can be a wide variety of sizes in various embodiments. For example, the granules 12 may have an average diameter of from about 0.1 to about 10 centimeters, where the average diameter is an average distance from an outer surface of the coating 16 through a center of the core 14 to the outer surface of the coating 16 opposite the starting point. In alternate embodiments, the granules have a diameter ranging from about 0.1 to about 5 centimeters, or from about 0.1 to about 2.5 centimeters, or from about 0.1 to about 1 centimeters, or from about 0.1 to about 0.5 centimeters, or from about 0.2 to 0.4 centimeters, but other diameter ranges are also possible. Unless stated otherwise, all particle sizes are Dv50 values.

The coating 16 overlies and may partially coat, substantially coat, or entirely coat and cover the outer surface 18 of the core 14, as mentioned above. As used here, the term “substantially coats” means at least about 75 area percent of the core 14 is covered with the coating 16. During the mixing process (described below), some of the material of the coating 16 may diffuse into pores, gaps, or spaces of the core 14, and at least partially coat the outer surface of the granule 12. To further clarify, the coating 16 is disposed on at least some of the outer surface 18 of the core 14, where the coating 16 may be in direct contact with the outer surface 18, or there may be an intermediate layer between the coating 16 and the outer surface 18. The outer surface 18 is the portion of the core 14 exposed to the environment, or in contact with the coating 16 or other layer disposed on the outer surface 18.

In an exemplary embodiment, the coating 16 overlies and covers from about 25 to 100 percent of the outer surface 18, such that some of the outer surface 18 may be free of the coating 16. In alternative embodiments, the coating 16 covers from about 50 to 100 percent of the outer surface 18 of the core 14, or from about 75 to 100 percent of the outer surface 18. The ranges of coverage described herein mean the individual granules 12 are covered within the specified range. As such, for a range of about 50 to 100 percent, some of the granules 12 may have a core outer surface 18 that is about 50 percent covered, and some of the granules 12 may have a core outer surface 18 that is 100 percent covered, with other granules 12 having a core outer surface 18 covered by any amount within the specified range.

In an exemplary embodiment, the core 14 primarily includes an elastomer. As used herein, the term “primarily” means more than 50%, based on weight. The elastomer in the core 14 may include, but is not limited to, one or more of styrene/butadiene/styrene copolymer (SBS), thermoplastic polyolefin elastomers (POE), thermoplastic olefin (TPO), styrene/butadiene rubber (SBR), styrene ethylene butylene styrene (SEBS), ethylene-glycidyl(meth)acrylate, ethylene-glycidyl(meth)acrylate terpolymers, cis-polyisoprene (natural rubber, NR), cis-polybutadiene (butadiene rubber, BR), glycidyl methacrylate grafted polyolefins, ground tire rubber, and combinations thereof. In an exemplary embodiment, the elastomer includes styrene-butadiene-styrene (SBS), and the SBS is present in the core 14 in an amount of from about 50 to 100 weight percent, based on a total weight of the core 14. It is possible for the core 14 to include some of the polyolefin, or some of one or more other ingredients in various embodiments, but the core 14 is primarily formed of the elastomer. The SBS can be linear SBS, radial SBS, star SBS, or combinations thereof. SBS can have high or low vinyl content, and SBS may contain oils in some embodiments.

The coating 16 is primarily composed of the polyolefin, such that the coating 16 includes from over 50 to 100 weight percent polyolefin. The coating 16 may include some elastomer in an exemplary embodiment, and other components may also be present in the coating 16, but the coating 16 is primarily polyolefin.

The polyolefin primarily includes a low molecular weight (LMW) polyolefin, where the “low molecular weight,” as used herein, means a weight average molecular weight of from about 500 to about 30,000 Daltons. The low molecular weight polyolefin is an olefin-containing polymer, or a blend of two or more olefin-containing polymers, each of which has a weight average molecular weight (M_{w}) of from about 500 to about 30,000 Daltons, and comprises one or more olefinic monomers, where the olefinic monomers are selected from: ethene, propene, butene, hexene, and octene. Thus, the LMW polyolefins may be homopolymers comprising only a single type of olefin monomer, or copolymers comprising two or more types of olefin monomers. Furthermore, LMW polyolefins, as this term is used herein, include but are not limited to polyolefin waxes, i.e., polyolefins which are solid at or near room temperature and have low viscosity when above their melting point. Some Fischer-Tropsch waxes, i.e., those that satisfy the above-defined characteristics of low molecular weight polyolefins but are produced from carbon monoxide and hydrogen, may also be used in the asphalt compositions contemplated and described herein.

Thermally degraded waxes are also examples of LMW polyolefins, where the thermally degraded waxes have a weight average molecular weight with the limit of from about 500 to about 30,000 Daltons, as mentioned above. The thermally degraded waxes may be formed from virgin polymers or recycled polymers in various embodiments. The low molecular weight polyolefins may be functionalized in some embodiments, where the low molecular weight polyolefin may be a functionalized homopolymer or a copolymer. In an exemplary embodiment, functionalized low molecular weight polyolefins comprise one or more functional groups including, but not limited to, an acid, an ester, an amine, an amide, an ether, and an anhydride such as maleic anhydride. Additionally, the low molecular weight polyolefins may be oxidized.

In an exemplary embodiment, the LMW polyolefins is an oxidized high density polyethylene. High density polyethylene has a density of from about 0.93 to about 0.97 grams per cubic centimeter (g/cc) or higher, and oxidized high density polyethylene has a density equal to or greater than high density polyethylene depending on the degree of oxidation. An exemplary oxidized high density polyethylene has a density of at least 0.93, 0.94, 0.95, 0.96, 0.97, 0.98, 0.99, or 1.00 g/cc. In contrast, low density polyethylene has a density of from about 0.91 to about 0.93 g/cc. Low density polyethylene tends to include multiple branches in the polymer chain, whereas high density polyethylene has minimal polymer branching. Oxidized polyethylene is a reaction product of polyethylene with oxygen, and may be produced by different techniques. Oxidized polyolefins will have an acid number, defined as the amount of potassium hydroxide in milligrams required to neutralize 1 gram of polyolefin under fixed conditions. One set of fixed conditions, for example, would be ASTM 1386-83.

In an exemplary embodiment, the low molecular weight polyolefin has an olefin content of from about 50 to 100 wt. %, based on the total weight of the low molecular weight polyolefin. An exemplary low molecular weight polyolefin has an olefin content in wt. %, based on the total weight of the low molecular weight polyolefin, of at least about 55, 60, 65, 70, 75, 80, 85, 90, or 95 wt. %, and independently, of not more than about 100, 98, 95, 92, 90, 85, 80, or 75 wt. %.

As already mentioned, in an exemplary embodiment the low molecular weight polyolefin has a weight average molecular weight (M_{w}) of from about 500 to about 30,000 Daltons. In various embodiments the low molecular weight polyolefin has a M_{w} in Daltons of at least about 500, 1,000, 2,000, 3,000, 4,000, 5,000, 6,000, 7,000, 8,000, or 9,000 and independently, of not more than about 30,000, 20,000, 15,000, 12,000, or 10,000. Where the low molecular weight polyolefin comprises a combination of more than one type of polyolefin, the M_{w} of each type of polyolefin in the combination may individually be within the above-stated range of about 500 to about 30,000 Daltons. The weight average molecular weight of the low molecular weight polyolefins of the present disclosure may be determined by gel permeation chromatography (GPC), which is a technique generally known in the art. For the purpose of GPC, the sample to be measured may be dissolved in 1,2,4-trichlorobenzene at about 140° C. and at a concentration of about 2.0 mg/ml. The solution (200 microliters (μL)) is injected into the GPC containing two PLgel 5 micrometer (μm) Mixed-D (300×7.5 mm) columns held at about 140° C. with a flow rate of about 1.0 mL/minute. The instrument may be equipped with two detectors, such as a refractive index detector and a viscosity detector. The molecular weight (weight average molecular weight, Mw) is determined using a calibration curve generated from a set of linear polyethylene narrow Mw standards.

Generally, suitable low molecular weight polyolefins include, without limitation, polyethylene homopolymers, polypropylene homopolymers, ethylene vinyl acetate (EVA), ethylene butyl acrylate (EBA), ethylene acrylic acid (EAA), Fischer-Tropsch waxes, thermally degraded waxes with virgin or waste plastic feedstocks, by-product waxes, copolymers of two or more of ethylene, propylene, butene, hexene and octene, functionalized derivatives of the homopolymers mentioned above, functionalized derivatives of the copolymers mentioned above, or combinations of unfunctionalized and functionalized low molecular weight polyolefins. Some Fischer-Tropsch waxes, i.e., those that satisfy the above-defined characteristics of low molecular weight polyolefins but are produced from carbon monoxide and hydrogen, may also be used in the asphalt compositions contemplated and described herein. Examples of suitable functionalized low molecular weight polyolefins include, without limitation, maleated polyethylene, maleated polypropylene, ethylene acrylic acid copolymers, ethylene vinyl acetate copolymers, oxidized polypropylene, oxidized polyethylene, including oxidized low and/or high density polyethylene, and combinations thereof.

In an exemplary embodiment, the low molecular weight polyolefin is selected from the group of polyethylene, oxidized polyethylene with an acid number of from about 5 to about 60 milligrams potassium hydroxide per gram (mg KOH/gm), polypropylene, maleated polypropylene, and combinations thereof. In alternate embodiments, the low molecular weight polyolefin is polyethylene, or oxidized polyethylene, or polypropylene, or maleated polypropylene, a co-polymer of ethylene and propylene, or combinations thereof.

Another optional component of the asphalt additive 10 is a crosslinking agent 20. The crosslinking agent 20 is primarily present in the coating 16, but small quantities may be found within the core 14 in some embodiments. The crosslinking agent 20 facilitates crosslinking of the elastomer, and the crosslinked elastomer can produce a superior asphalt composition, as compared to an asphalt composition of about the same components where the elastomer is not crosslinked. For example, crosslinked elastomers in asphalt tend to produce better compatibility of the bitumen and polymers, higher ball and ring softening points, better heated storage stability, etc.

Examples of crosslinking agents 20 include sulfur, sulfur-providing compounds (i.e., including but not limited to hydrocarbyl polysulfides, thiuram disulfides, dithiocarbamates, sulfur containing oxazoles, sulfur donating vulcanization accelerators, benzothiazoles, diphenylguanidine, and other thiazole derivatives), polyphosphoric acid, non-sulfur vulcanization accelerators, phenolic resins, phenol formaldehyde resins, phenol aldehydes resins, urethanes, peroxides, metal oxides, selenium, and combinations thereof. In an exemplary embodiment, the crosslinking agent 20 is sulfur, a sulfur providing compound, or a combination thereof.

When the asphalt additive 10 is intended for asphalt used in paving roads, an oil may also be included. Exemplary oils include, but are not limited to, flux oils, paraffin, aromatic and naphthenic oils, bio oils, corn oils, soybean oils, tall oils, reclaimed oil, recycled engine oils, recycled engine oil bottom (REOB), and combinations thereof. The oils are generally incorporated into the coating 16, but some oil may also be present in the core 14.

When the asphalt additive 10 is intended for roofing materials, other optional ingredients may also be included. For example, the asphalt additive 10 may include fire retardant materials or flame retardant materials, such as halogenated flame retardants (for example, chlorinated flame retardants (CFRs), brominated flame retardants (BFRs)), phosphorus flame retardants (PFRs), nitrogen-base flame retardants (NFRs), inorganic flame retardants (for example, compounds based on nitrogen, graphite, silica, ammonium phosphate, polyphosphate, clay, carbon black, metal oxides, hydroxides, etc.), and combinations thereof. The asphalt additive 10 may also, or alternatively, include anti-fungal materials, such as inorganic algaecides (for example, metals (copper, zinc, silver, etc.), metal oxides (cuprous oxides, zinc oxide, titanium dioxide, etc.), copper-containing compounds, zinc-containing compounds, silver-containing compounds, etc., organic algaecides (for example, didecyl dimethyl ammonium chloride, sodium dimethyldithiocarbamate, etc.), and combinations thereof.

Other optional ingredients include anti-oxidants, such as inorganic anti-oxidants (for example, carbon black, hydrated lime, calcium hydroxide, etc.), and organic anti-oxidants (for example, polyphenols, tocopherols, sterically hindered phenols, aromatic amines, zinc diethyldithiocarbamate, zinc dithiocarbonates, organic phenylamines, phenothiazine, phosphites, thioesters, lignins, ascorbic acids, etc.), and combinations thereof. Other optional ingredients include light stabilizers, such as UV absorbers (for example, benzophenones, benzotriazoles, etc.), nickel quenchers, hindered amine light stabilizers (HALS), etc., and combinations thereof. When the asphalt additive 10 is intended for asphalt used in roofing materials, an oil may also be included. Exemplary oils include, but are not limited to, flux oils, paraffin, aromatic and naphthenic oils, bio oils, corn oils, soybean oils, tall oils, reclaimed oil, recycled engine oils, recycled engine oil bottom (REOB), and combinations thereof. The oils are generally incorporated into the coating 16, but some oil may also be present in the core 14. Additional components may also be included. In general, the additional components are primarily present in the coating 16, and the core 14 is primarily the elastomer. The asphalt additive 10 for roofing purposes may be free of the crosslinking agent 20 that is optionally included in the asphalt additive 10 for road paving purposes.

The components in the asphalt additive 10 are provided within a concentration range suitable for the intended purpose. For example, when the intended purpose is for road paving, the elastomer may be present in an amount of from about 50 to about 90 weight percent, the polyolefin may be present in an amount of from about 10 to about 50 weight percent, the crosslinking agent 20 (when included) may be present in amount of from about 0.01 to about 10 weight percent, and the oil (when included) may be present in an amount of from about 5 to about 35 weight percent, all based on a total weight of the asphalt additive 10. In alternate embodiments, the elastomer may be present in an amount of from about 60 to about 80 weight percent, or from about 70 to about 80 weight percent, based on the total weight of the asphalt additive 10. The polyolefin may be present in an amount of from about 15 to about 40 weight percent, or from about 15 to about 30 weight percent, based on the total weight of the asphalt additive 10. The crosslinking agent 20, when included, may be present in an amount of from about 0.1 to about 10 weight percent, or from about 1 to about 5 weight percent, and the oil, when included, may be present in an amount of from about 5 to about 35 weight percent, all based on the total weight of the asphalt additive 10.

The ratio of components for the asphalt additive 10, when intended for roofing materials, is somewhat different than the ratios when intended for road surfaces. For roofing materials, the asphalt additive 10 may include from about 30 to about 90 weight percent elastomer, from about 10 to about 70 weight percent polyolefin, from about 5 to about 35 weight percent oil (if included), and from about 1 to about 5 weigh percent each for the fire retardant, the anti-fungal material, the anti-oxidants, the light stabilizer, and any other additional additives, if present at all, all based on the total weight of the asphalt additive 10. In alternate embodiments, the elastomer may be present in an amount of from about 50 to about 80 weight percent, from about 20 to about 50 weight percent polyolefin, optionally from about 10 to about 25 weight percent oil, and from about 1 to about 5 weight percent for each of the fire retardant, anti-fungal material, the anti-oxidant, the light stabilizer, and any other optional additional additives, if present at all, all based on the total weight of the asphalt additive 10.

### Method for Producing the Asphalt Additive

Reference is made to FIG. 2, with continuing reference to FIG. 1. In general, the components are mixed at a mixing temperature 34 to produce the asphalt additive 10. Several different embodiments are provided for production of the asphalt additive, but the difference in the various embodiments is the lower limit and/or the upper limit of the mixing temperature 34. Modifications to the lower limit or the upper limit of the mixing temperature 34 can influence (i) the mixing time needed to produce the asphalt additive, (ii) the degree of coverage of the coating over the core, and (iii) the degree of degradation of the materials in the asphalt additive. As mentioned above, the degree of degradation is small, because the upper limit of the mixing temperature 34 is low enough that degradation is limited.

The upper limit of the mixing temperature 34 may be varied in some embodiments, such as when sulfur is present as a crosslinking agent. Handling sulfur includes some hazards, where sulfur is one example of a crosslinking agent 20, and lower processing temperatures reduce the hazards when compared to higher processing temperatures. Sulfur has a flash point from about 160° C. to about 210 degrees Celsius (° C.), so processing temperatures below 160° C. are preferred when sulfur is present. Sulfur is available in various grades, impurity levels, etc., at may be tested by different techniques, so the sulfur flash point is a range. Furthermore, the upper limit of the mixing temperature 34 may be limited to no more than an elastomer peak melting point, an elastomer onset melting point, an elastomer softening point, a sulfur flash point, a polyolefin onset melting point, a polyolefin peak melting point, a polyolefin softening point, or other temperatures in various embodiments. In general, the upper limit of the mixing temperature 34 is such that the elastomer does not entirely melt, and remains as solid or semi-solid mass that serves as the core 14. The solid or semi-solid core 14 accumulates the coating 16 during the mixing process.

The mixing temperature 34 is defined by several possible parameters in the various embodiments. These parameters include: the onset melting point, the peak melting point, and the softening point of the polyolefin and/or the elastomer. For clarity, these terms are defined here. The softening point of the elastomer may be determined according to ASTM D 1525 (“Standard Test Method for Vicat Softening Temperature of Plastics”) or ASTM D 36 (“Standard Test Method for Softening Point of Bitumen (Ring-and-Ball Apparatus)”). The softening point of polyolefin may be determined according to ASTM D 36 (“Standard Test Method for Softening Point of Bitumen (Ring-and-Ball Apparatus)”). The onset melting point and the peak melting point of polyolefin and elastomer may be determined according to ASTM D 1519 (“Standard Test Methods for Rubber Chemicals Determination of Melting Range, TEST METHOD B—DIFFERENTIAL SCANNING COLORIMETRY”).

The lower limit of the mixing temperature 34 can be any of several different values, in various embodiments. For example, the lower limit of the mixing temperature 34 can be: (i) a polyolefin onset melting point; (ii) an elastomer softening point; (iii) a polyolefin peak melting point; (iv) a polyolefin softening point; and (v) an elastomer onset melting point. These various lower limits for the mixing temperature 34 can be combined in any way with the upper limits for the mixing temperature 34 described above. Therefore, in various embodiments, the mixing temperature 34 can be: (a) a polyolefin onset melting point to an elastomer peak melting point; (b) a polyolefin onset melting point to a sulfur flash point; (c) a polyolefin onset melting point to an elastomer onset melting point; (d) a polyolefin onset melting point to a polyolefin peak melting point; (e) a polyolefin onset melting point to a polyolefin softening point; (f) a polyolefin peak melting point to an elastomer peak melting point; (g) a polyolefin peak melting point to a sulfur flash point; (h) a polyolefin peak melting point to an elastomer onset melting point; (i) a polyolefin peak melting point to a polyolefin softening point; (j) a polyolefin softening point to an elastomer peak melting point; (k) a polyolefin softening point to a sulfur flash point; (l) a polyolefin softening point to an elastomer onset melting point; (m) a polyolefin softening point to a polyolefin peak melting point; (n) a polyolefin softening point to a polyolefin onset melting point; (o) an elastomer softening point to an elastomer peak melting point; (p) an elastomer softening point to a sulfur flash point; (q) an elastomer softening point to an polyolefin softening point; (r) an elastomer softening point to an elastomer onset melting point; (s) an elastomer onset melting point to an elastomer peak melting point; (t) an elastomer onset melting point to an sulfur flash point; and (u) a polyolefin onset melting point to a polyolefin peak melting point; and (v) other possible upper and lower mixing temperatures 34.

Styrene-butadiene-styrene (SBS) is one embodiment of an elastomer 30 that may be used, and SBS may have a melting range of from about 120-160 (onset melting point) to 200-240° C. (peak melting point). SBS may have a Ring & Ball softening point of from 70 to 100° C. The melting points, or melting range and the Ring & Ball softening point, of the elastomer 30 may vary, and the elastomer 30 may be selected such that the elastomer 30 remains a solid during the mixing process.

Low molecular weight polyethylene is one embodiment of a polyolefin 32 that may be used, and low molecular weight polyethylene may have a melting range of from about 60-90 (onset melting point) to 100-160° C. (peak melting point). Low molecular weight polyethylene may have a Ring & Ball softening point of about 110-160° C. The melting points, or melting range and the Ring & Ball softening point, of the low molecular weight polyethylene 32 may vary. As described above, a wide range of elastomers 30 may be used, as well as a wide range of polyolefins 32, so one skilled in the art can select appropriate components for this embodiment.

Processing the asphalt additive 10 at lower temperatures produces a product with less degradation of the components, and also reduces premature crosslinking of the elastomer. The premature crosslinking of the elastomer is exacerbated in embodiments where the crosslinking agent 20 is included in the asphalt additive 10, and processing at lower temperatures has been found to minimize unwanted preliminary elastomer crosslinking. Reduced costs from heating are another benefit of processing the asphalt additive 10 at lower temperatures. Handling sulfur includes some hazards, where sulfur is one example of a crosslinking agent 20, and lower processing temperatures reduce the hazards when compared to higher processing temperatures, as mentioned above. Furthermore, the asphalt additive 10 as described herein is a particulate material that may be less dense than extruded additives. This can produce a product that easier to disperse and incorporate into a asphalt product, and may also facilitate a more even distribution of the asphalt additive 10 in the asphalt such that better overall performance is achieved, as compared to an extruded product.

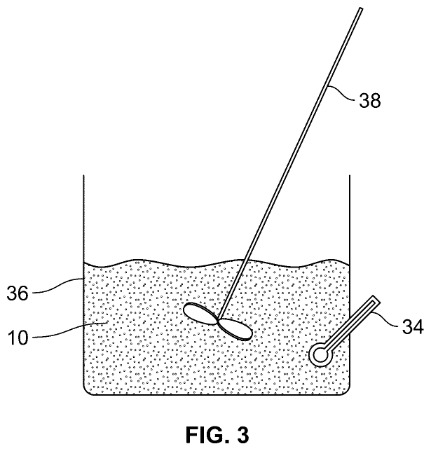

Referring to FIGS. 2 and 3, with continuing reference to FIG. 1, the production of the asphalt additive 10 includes combining the elastomer 30, the polyolefin 32, and any other components included in the desired embodiment of the asphalt additive 10, and mixing them together at a mixing temperature 34 until the polyolefin 32 produces the coating over the elastomer 30 in the core 14.

The polyolefin 32 and the elastomer 30 are combined to produce a premix 22, as illustrated in FIG. 2, where the premix 22 is a combination of the polyolefin 32 and the elastomer 30 when the polyolefin 32 has not formed the final coating 16 over the core 14. Additional optional components may or may not be included in the premix 22 in various embodiments. The polyolefin 32 may be added to form the premix 22 in a variety of states, such as in a solid state, a semisolid state, or even a molten state. As such, the polyolefin 32 may be at or below a polyolefin onset melting point at the time of addition, such that the polyolefin 32 is a solid. However, in alternate embodiments, the polyolefin 32 may be at or above the polyolefin onset melting point and/or the polyolefin softening point, and may be below the polyolefin peak melting point such that the polyolefin 32 is a semi-solid. The polyolefin 32 may also be at or above the polyolefin peak melting point at the time of addition, such that the polyolefin 32 is molten. When the polyolefin 32 is added in a molten state, the premix 22 may transform into the asphalt additive 10 rapidly, but there is at least a brief period before the coating 16 is formed in a final state over the core 14 such that the combination is in a premix state. In a similar manner, the elastomer 30 may be in a solid or semi-solid state at the time of addition. For example, if the elastomer 30 is at or below the elastomer softening point and/or the elastomer onset melting point, the elastomer 30 may be in a solid state. If the elastomer 30 is at or above the elastomer onset melting point and/or the elastomer softening point, but below the elastomer peak melting point, the elastomer 30 may be in a semi-solid state. Furthermore, the order of the addition of the elastomer 30 and the polyolefin 32 may be varied in any manner in various embodiments, as well as the order of addition of any additional components other than the elastomer 30 and polyolefin 32. FIG. 3 illustrates the process when the coating 16 is fully formed over the core 14, such that the asphalt additive 10 is produced from the premix 22 (illustrated in FIG. 2).

Optional extra ingredients in the asphalt additive 10 include the crosslinking agent 20 and the other optional ingredients (not specifically illustrated in FIG. 2), as mentioned above. The components may be combined at any temperature, and brought to the mixing temperature 34 by heating, or by the heating effect of agitation, or by any appropriate technique. The mixing temperature 34 is at a temperature sufficient to form a coating 16 of the polyolefin on the elastomer 14.

The coating 16 overlies and may partially coat, substantially or entirely coat the outer surface 18 of the core 14, as mentioned above. During the mixing process, some of the coating material 16 may diffuse into the pores of the core material 14, and at least partially coat the outer surface of the granule 12. The mixing equipment suitable for this invention includes, but not limited to, Banbury®, Henschel®, etc.

The high speed mixing of the polyolefin 32 and the elastomer 30 at the mixing temperature 34 allows for the polyolefin 32 to deform and “wrap around” the elastomer 30 to produce the core 14 and coating 16 structure described above. Other components included in the mixing process are generally incorporated into the polyolefin coating 16, because the softened polyolefin allows for inclusion of particulates and/or liquids into the polyolefin structure during the high speed mixing process. A small amount of any additional components may be included in the elastomer core 14, because the material may become trapped in a crevice or pore.

The components are combined in a mixer 36 and mixed, such as with a mixing implement 38, at the mixing temperature 34 until the core outer surface 18 is partially, substantially, or entirely covered by the coating 16. The mixer 36 may be a vessel, a ribbon blender, a homogenizer, a planetary mixer, a drum mixer, a paddle mixer, or any other type of mixer that can satisfactorily mix the components. The mixing implement 38 may be an agitator, a ribbon mixer, a sonicator, or any other type of implement that can produce the mixing for properly coating the core 14. In some embodiments, the mixer 36 may not include a separate mixing implement 38, such as in a cement truck where the mixing implement 38 is formed into the mixer 36. Any other device which can mix the components can also be used for the mixer 36, and a mixing implement 38 may be optional in some types of devices used for mixing.

The combined components may be mixed in a high speed mixer 36, and the energy produced from the mixing action may increase the temperature to the mixing temperature 34. Alternatively, a heating implement (not illustrated) or temperature control system (also not illustrated) may be used to increase and/or control the temperature to within a desired range of the mixing temperature 34. Mixing times can vary widely, so long as the polyolefin forms a coating 16 affixed to the outer surface 18 of the core 14. In an exemplary embodiment, a mixing time of 30 minutes in a high speed mixer with an agitation rate of 800 to 1,400 revolutions per minute (RPM) has produced a coated core product, when using low molecular weight polyethylene as the polyolefin 32, SBS as the elastomer 30, and elemental sulfur as the crosslinking agent 20.

In an exemplary embodiment, a mixing time of 30 minutes in a high speed mixer with an agitation rate of 800 to 1,400 revolutions per minute (RPM) has produced a coated core product, when using low molecular weight polyethylene as the polyolefin 32, SBS as the elastomer 30, and elemental sulfur as the crosslinking agent 20, at a mixing temperature 34 below about 160° C. In another exemplary embodiment, a mixing time of 30 minutes in a high speed mixer with an agitation rate of 800 to 1,400 revolutions per minute (RPM) has produced a coated core product, when using low molecular weight polyethylene as the polyolefin 32 and SBS as the elastomer 30 at a mixing temperature 34 below about 240° C.

In some embodiments, the polyolefin 32 may be melted into a liquid state, and coat the elastomer core 14. Then, the coated product may be cooled to re-solidify the polyolefin 32 as the coating 16 overlying the core 14. Varying levels of softened or molten polyolefin 32 may be utilized in various embodiments.

In an exemplary embodiment, the polyolefin 32 is in a liquid state and sprayed onto the elastomer 30 that is in a solid state, as mentioned above. The elastomer 30 may be at a temperature less than the polyolefin melting point, such that the molten polyolefin freezes and sticks to the elastomer 30 on contact and thus forms the polyolefin coating 16 overlying the elastomer core 14. Any additional components may be included in the molten polyolefin 32 for this embodiment. In another embodiment, both the elastomer 30 and the polyolefin are above the polyolefin melting point when the polyolefin 32 is sprayed onto the elastomer 30. Alternatively, the polyolefin 32, elastomer 30, and any other optional components that may be present are combined at a temperature below the polyolefin melting point, and then the components are mixed and heated to the mixing temperature 34. The quantity of polyolefin 32 and optional additional ingredients may be increased or otherwise adjusted to account for residue that may remain in the mixer 36.

In yet another embodiment, molten polyolefin 32 may be combined with solid elastomer 30 and any other optional additional ingredients at a temperature above the polyolefin peak melting point, and all the components are mixed until the asphalt additive 10 is produced. Additional embodiments are possible, such as combining the components and mixing in a fluidized bed, as is understood by one skilled in the art. The polyolefin 32 and/or other optional components may flow into cracks, crevices, pores, etc. in the oligomer core 14, but the core 14 remains as a distinct, differentiable component from the coating 16. It is also possible to produce more than a single coating, such as by cooling a first coating and then applying a second coating overlying the first coating. Therefore, a plurality of different polyolefins 32 may be used, and the different polyolefins 32 may be in different layers in the asphalt additive 10.

While several embodiments have been presented in the foregoing detailed description, it should be appreciated that a vast number of variations exist. It should also be appreciated that the embodiment or embodiments are only examples, and are not intended to limit the scope, applicability, or configuration of this disclosure in any way. Rather, the foregoing detailed description will provide those skilled in the art with a convenient road map for implementing various embodiments of the asphalt compositions, it being understood that various changes may be made in the function and arrangement of elements described without departing from the scope as set forth in the appended claims and their legal equivalents.

What is claimed is:

1. An asphalt additive comprising:
a granule, wherein the granule comprises;
a core having an outer surface and comprising an elastomer;
a coating disposed on the outer surface of the core, wherein the coating comprises a polyolefin.

2. The asphalt additive of claim 1, further comprising a crosslinking agent, wherein the crosslinking agent is primarily present in the coating.

3. The asphalt additive of claim 2, wherein the crosslinking agent comprises one or more of sulfur, sulfur-providing compounds, polyphosphoric acid, non-sulfur vulcanization accelerators, phenolic resins, phenol formaldehyde resins, phenol aldehydes resins, urethanes, peroxides, metal oxides, and selenium.

4. The asphalt additive of claim 1, wherein the elastomer is selected from the group of styrene/butadiene/styrene copolymer (SBS), thermoplastic polyolefin elastomers (POE), thermoplastic olefin (TPO), styrene/butadiene rubber (SBR), styrene ethylene butylene styrene (SEBS), ethylene-glycidyl(meth)acrylate, ethylene-glycidyl(meth)acrylate terpolymers, cis-polyisoprene (natural rubber, NR), cis-polybutadiene (butadiene rubber, BR), glycidyl methacrylate grafted polyolefins, ground tire rubber, and combinations thereof.

5. The asphalt additive of claim 1, wherein the elastomer comprises styrene-butadiene-styrene (SBS).

6. The asphalt additive of claim 1, wherein the polyolefin is selected from the group of polyethylene homopolymers, polypropylene homopolymers, ethylene vinyl acetate (EVA), ethylene butyl acrylate (EBA), ethylene acrylic acetate (EAA), Fischer-Tropsch waxes, thermally degraded waxes with virgin or waste plastic feedstocks, by-product waxes, copolymers of two or more of ethylene, propylene, butene, hexene and octene, functionalized derivatives of the homopolymers mentioned above, functionalized derivatives of the copolymers mentioned above, and combinations thereof.

7. The asphalt additive of claim 1, wherein the polyolefin has a weight average molecular weight of from about 500 to about 30,000 Daltons.

8. The asphalt additive of claim 1, wherein the polyolefin is oxidized, and wherein the polyolefin has an acid number of from about 5 to about 60 milligrams potassium hydroxide per gram (mg KOH/gm).

9. The asphalt additive of claim 1, wherein: the polyolefin comprises oxidized high density polyethylene.

10. The asphalt additive of claim 1, wherein:
the core comprises styrene-butadiene-styrene (SBS) in an amount of from about 50 to 100 weight percent, based on a total weight of the core;
the coating primarily comprises an oxidized high density polyethylene having a weight average molecular weight of from about 500 to about 30,000 Daltons, wherein the coating further comprises sulfur, and wherein the coating covers from about 25 to 100 percent of the outer surface of the core; and
wherein the asphalt additive comprises the SBS in an amount of from about 50 to about 90 weight percent, the oxidized polyethylene in an amount of from about 10 to about 50 weight percent, and the sulfur in an amount of from about 0.1 to about 10 weight percent, all based on a total weight of the asphalt additive.

11. A method of producing an asphalt additive, the method comprising the steps of:
combining an elastomer and a polyolefin to produce a premix, wherein the premix comprises the elastomer and the polyolefin;
bringing a temperature of the premix to a mixing temperature, wherein the mixing temperature is a temperature sufficient to form a coating of the polyolefin over the elastomer; and
mixing the premix at the mixing temperature to form a granule, wherein the granule comprises the coating overlying an outer surface of a core, wherein the core comprises the elastomer in an amount of from about 50 to 100 weight percent, based on a total weight of the core, and wherein the coating comprises the polyolefin in an amount of from about 70 to 100 weight percent, based on a total weight of the coating.

12. The method of claim 11, further comprising:
adding a crosslinking agent to the premix.

13. The method of claim 12, wherein the crosslinking agent is sulfur, and the mixing temperature is less than about 160 degrees Celsius.

14. The method of claim 11, wherein the polyolefin is at or above a polyolefin onset melting point when combined with the elastomer to produce the premix.

15. The method of claim 11, wherein the polyolefin is at or above a polyolefin peak melting point when combined with the elastomer to produce the premix.

16. The method of claim 11, wherein the mixing temperature is from about a polyolefin onset melting point to about an elastomer peak melting point.

17. The method of claim 11, wherein the mixing temperature is from about a polyolefin onset melting point to an elastomer softening point.

18. The method of claim 11, wherein the mixing temperature is from about a polyolefin onset melting point to polyolefin peak melting point.

19. The method of claim 11, wherein the elastomer comprises styrene/butadiene/styrene copolymer (SBS).

20. The method of claim 11, wherein the polyolefin comprises oxidized high density polyethylene.
